(19) United States
(12) Patent Application Publication
(10) Pub. No.: US 2008/0276627 A1
(43) Pub. Date: Nov. 13, 2008

(54) FUEL GAS SUPPLY SYSTEM AND METHOD OF A SHIP

(75) Inventors: Jung Han Lee, Geoje-si (KR); Dong Kyu Choi, Geoje-si (KR); Hyun Ki Park, Geoje-si (KR)

Correspondence Address: SEED INTELLECTUAL PROPERTY LAW GROUP PLLC, 701 FIFTH AVE, SUITE 5400, SEATTLE, WA, 98104, US

(73) Assignee: DAEWOO SHIPBUILDING & MARINE ENGINEERING CO., LTD., Seoul (KR)

(21) Appl. No.: 12/055,118

(22) Filed: Mar. 25, 2008

Related U.S. Application Data
(63) Continuation-in-part of application No. 12/028,207, filed on Feb. 8, 2008.

(30) Foreign Application Priority Data
May 8, 2007 (KR) 10-2007-0044727
Nov. 27, 2007 (KR) 10-2007-0121558
Nov. 30, 2007 (KR) 10-2007-0123679
Mar. 5, 2008 (KR) 10-2008-0020356

(51) Int. Cl. F02M 21/02; F17C 7/04

(52) U.S. Cl. 62/7; 62/50.3; 123/495

(57) ABSTRACT

A fuel gas supply system of a ship is provided for supplying fuel gas to a high-pressure gas injection engine of the ship, wherein the ship has an LNG fuel tank for storing LNG as fuel and LNG is extracted from an LNG fuel tank of the ship, compressed at a high pressure, gasified, and then supplied to the high-pressure gas injection engine.

### CROSS-REFERENCE TO RELATED APPLICATION

This application is a continuation-in-part of U.S. patent application Ser. No. 12/028,207, filed Feb. 8, 2008, now pending, which application is incorporated herein by reference in its entirety.

### BACKGROUND

1. Technical Field

The present invention relates to a fuel gas supply system and method of a ship, and more particularly, to a fuel gas supply system and method of a ship for efficiently supplying fuel gas from an LNG fuel tank to a high-pressure gas injection engine in the ship.

2. Description of the Related Art

Generally, a ship could be propelled using liquefied natural gas (hereinafter called “LNG”) as fuel. In this case, the ship has an LNG fuel tank for storing LNG as fuel.

As liquefaction of natural gas occurs at a cryogenic temperature of −163 degrees Celsius at ambient pressure, LNG is likely to be vaporized even when the temperature of the LNG is slightly higher than −163 degrees Celsius at ambient pressure. In a ship having an LNG fuel tank which is thermally-insulated, as heat is continually transmitted from the outside to the LNG in the LNG fuel tank, the LNG is continually vaporized and boil-off gas is generated in the LNG fuel tank on a voyage of the ship.

In a ship, if boil-off gas is accumulated in an LNG fuel tank, there is a problem that the pressure in the LNG fuel tank excessively increases.

In a case where a high-pressure gas injection engine, for example, MEGI engine manufactured by MAN B&W Diesel Inc., is used as a ship propulsion engine of a ship, there are problems that configuration for supplying high-pressure fuel gas from the LNG fuel tank to the high-pressure gas injection engine is very complex and an excessive amount of power is required to supply high-pressure fuel gas from the LNG fuel tank to the high-pressure gas injection engine.

### BRIEF SUMMARY

To solve the above-mentioned problems posed by the related art, embodiments of the present invention provide a fuel gas supply system and method of a ship which can simplify the configuration, reduce power requirements, and prevent an excessive pressure increase due to accumulation of boil-off gas in an LNG fuel tank, in supplying fuel gas to a high-pressure gas injection engine of the ship.

A fuel gas supply system of a ship according to one embodiment of the present invention, as a system for supplying fuel gas to a high-pressure gas injection engine of a ship, is characterized in that the ship has an LNG fuel tank for storing LNG as fuel, and LNG is extracted from the LNG fuel tank of the ship, compressed at a high pressure, gasified, and then supplied to the high-pressure gas injection engine.

A fuel gas supply method of a ship according to one embodiment of the present invention, as a method for supplying fuel gas to a high-pressure gas injection engine of a ship, is characterized in that LNG is extracted from an LNG fuel tank of the ship having the LNG fuel tank for storing LNG as fuel, compressed to meet the pressure requirements for the high-pressure gas injection engine, gasified, and then supplied to the high-pressure gas injection engine.

### BRIEF DESCRIPTION OF THE SEVERAL VIEWS OF THE DRAWINGS

FIG. 1 is a schematic view of a fuel gas supply system of a ship according to an embodiment of the present invention;

FIG. 2 is a schematic view of a fuel gas supply system of a ship according to another embodiment of the present invention; and

FIG. 3 is a schematic view of a fuel gas supply system of a ship according to yet another embodiment of the present invention.

### DETAILED DESCRIPTION

Preferred embodiments of the present invention will be described in detail below with references to the accompanying drawings.

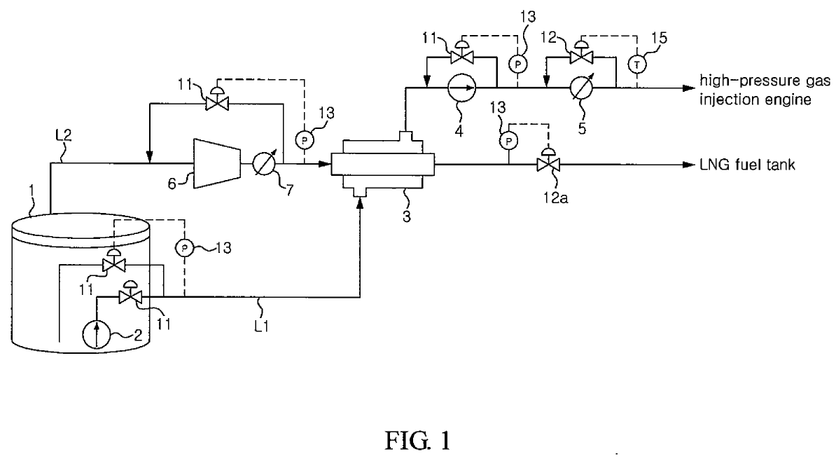

FIG. 1 is a schematic view of a fuel gas supply system of a ship according to an embodiment of the present invention. As illustrated in FIG. 1, the fuel gas supply system of the ship is to supply fuel gas to a high-pressure gas injection engine of the ship.

The fuel gas supply system of FIG. 1 includes a fuel gas supply line L1 for supplying LNG extracted from an LNG fuel tank 1 of the ship to a high-pressure gas injection engine of the ship, and a heat exchanger 3 installed in the middle of the fuel gas supply line L1 so as to exchange heat between LNG and boil-off gas extracted from the LNG fuel tank 1.

It is preferable to use an LNG storage tank generally used for an LNG carrier as the LNG fuel tank. The LNG storage tanks for the LNG carrier are known in the related art as described below.

First, the LNG storage tank for the LNG carrier can be classified into an independent type tank and a membrane type tank. This classification of the LNG storage tank depends on whether or not the load of cargo directly acts on the thermal insulation wall, and is described in detail hereinafter.

In the following Table 1, GTT No. 96-2 and GTT Mark III have been renamed from GT and TGZ, respectively, when the names of Gaz Transport (GT) Corporation and Technigaz (TGZ) Corporation was changed to GTT (Gaz Transport & Technigaz) Corporation in 1999.

TABLE 1

| | Membrane Type | | Independent Type | |
|---|---|---|---|---|
| Classification | GTT Mark III | GTT No. 96-2 | MOSS | IHI-SPB |
| Material- | SUS 304L- | Invar steel- | Al alloyed | Al alloyed |
| thickness of tank | 1.2 mm | 0.7 mm | steel (5083)- | steel (5083) |
| | | | 50 mm | Max. 30 mm |
| Material for heat | Reinforced | Plywood | Polyurethane | Polyurethane |
| dissipation- | Polyurethane | Box + Perlite- | Foam-250 mm | Foam-250 mm |
| thickness | Foam-250 mm | 530 mm | | |

GT type and TGT type tanks are disclosed in U.S. Pat. Nos. 6,035,795, 6,378,722, and No. 5,586,513, US Patent Publication No. 2003-0000949, and Korean Patent Laid-open Publication Nos. 2000-0011347 and 2000-0011346.

Korean Patent Nos. 499710 and 0644217 disclose thermal insulation walls embodied according to other conceptions.

As such, there are many conventional LNG storage tanks for the LNG carrier having variously shaped thermal insulation walls, all of which are designed to suppress the boil-off gas generation as much as possible.

Further, it is possible to use a high-pressure LNG storage tank designed to withstand high pressure more than 2 bars (gauge pressure).

The fuel gas supply line L1 upstream of the heat exchanger 3 has a first pump 2 for compressing the LNG to meet the pressure requirements for the high-pressure gas injection engine and supplying the LNG toward the high-pressure gas injection engine. According to this embodiment, the first pump 2 is illustrated as installed in the LNG fuel tank, but may be installed in the fuel gas supply line L1 upstream of the heat exchanger 3 outside the LNG fuel tank 1. Also, the first pump 2 may comprise one pump or two pumps.

A boil-off gas liquefaction line L2 is connected from an upper portion of the LNG fuel tank 1, passing through the heat exchanger 3, to one side of the LNG fuel tank 1. The boil-off gas is extracted from an upper portion of the LNG fuel tank 1, passes through the heat exchanger 3, and is returned to one side of the LNG fuel tank 1.

In the heat exchanger 3, the LNG exchanges heat with the boil-off gas to increase the temperature of the LNG and then the LNG is supplied toward the high-pressure gas injection engine, and the boil-off gas is liquefied by heat exchange with the LNG and then returned to the LNG fuel tank 1. If the boil-off gas in an upper portion of the LNG fuel tank 1 is liquefied and returned to a lower portion of the LNG fuel tank 1, it can prevent the pressure in the LNG fuel tank from excessively increasing due to accumulation of the boil-off gas in the LNG fuel tank 1.

In one embodiment, a second pump 4 is installed in the fuel gas supply line L1 downstream of the heat exchanger 3 so as to compress the LNG which has exchanged heat with the boil-off gas to meet the pressure requirements for the high-pressure gas injection engine, and then to supply the compressed LNG to the high-pressure gas injection engine.

A heater 5 is installed in the fuel gas supply line L1 downstream of the second pump 4 so as to heat the LNG which has exchanged heat in the heat exchanger 3, and then to supply the heat exchanged LNG to the high-pressure gas injection engine.

In one embodiment, boil-off gas compressor 6 and a cooler 7 are installed in the boil-off gas liquefaction line L2 upstream of the heat exchanger 3 so as to compress and cool the boil-off gas extracted from the LNG fuel tank 1 before the exchange of heat between the boil-off gas and the LNG.

In a case where the high-pressure gas injection engine is, for example, an MEGI engine manufactured and sold by MAN B&W Diesel Inc., the pressure of the fuel gas required for the MEGI engine can range from 200 to 300 bar (gauge pressure), preferably 250 bar (gauge pressure). The LNG is compressed to 27 bar (gauge pressure) in the first pump 2, and the temperature of the LNG increases from approximately −163 degrees Celsius to approximately −100 degrees Celsius while passing through the heat exchanger 3, and the LNG in a liquid state is supplied to the second pump 4 and compressed to approximately 250 bar (gauge pressure) in the second pump 4 (as it is in a supercritical state, there is no division between liquid and gas states), then heated in the heater 5, and then supplied to the high-pressure gas injection engine. In this case, as the pressure of the LNG supplied to the heat exchanger 3 is high, the LNG, though its temperature increases by passing through the heat exchanger, is not gasified.

Flow rate control-type pressure control valves 11 are installed in the fuel gas supply line L1 at the front and rear of the first pump 2, in the fuel gas supply line L1 at the front and rear of the second pump 4, and in the boil-off gas liquefaction line L2 at the front and rear of the boil-off gas compressor 6 and the cooler 7, so as to control the pressure of the fluid passing through the lines.

Also, flow rate control-type temperature control valves 12 are installed in the fuel gas supply line 11 at the front and rear of the heater 5 so as to control the temperature of the fluid passing though the line.

Pressure sensors 13 are connected between the fuel gas supply line L1 at a rear end of the first pump 2, the fuel gas supply line L1 at a rear end of the second pump 4, the boil-off gas liquefaction line L2 at a rear end of the boil-off gas compressor 6 and the cooler 7, and the pressure control valves 11. Also, temperature sensors 15 are connected between the fuel gas supply line L1 at a rear end of the heater 5 and the temperature control valves 12.

The flow rate control-type pressure control valves 11 and temperature control valve 12 control the flow rate, thereby controlling the pressure or temperature of the fluid passing through themselves.

Also, an expandable pressure control valve 12a is installed in the middle of the boil-off gas liquefaction line L2 downstream of the heat exchanger 3 so as to control the pressure of the fluid passing through the line L2.

The pressure sensor 13 is connected between the pressure control valve 12a and the boil-off gas liquefaction line L2 at a front end of the pressure control valve 12a installed in the boil-off gas liquefaction line L2 downstream of the heat exchanger 3.

The pressure control valve 12a installed in the boil-off gas liquefaction line L2 downstream of the heat exchanger 3 expands the passing fluid so as to correspond to the pressure which is obtained by adding the pressure of the LNG fuel tank 1 to the pressure due to water head of the LNG in the LNG fuel tank 1, thereby controlling the pressure, and the temperature of the LNG decreases by the expansion.

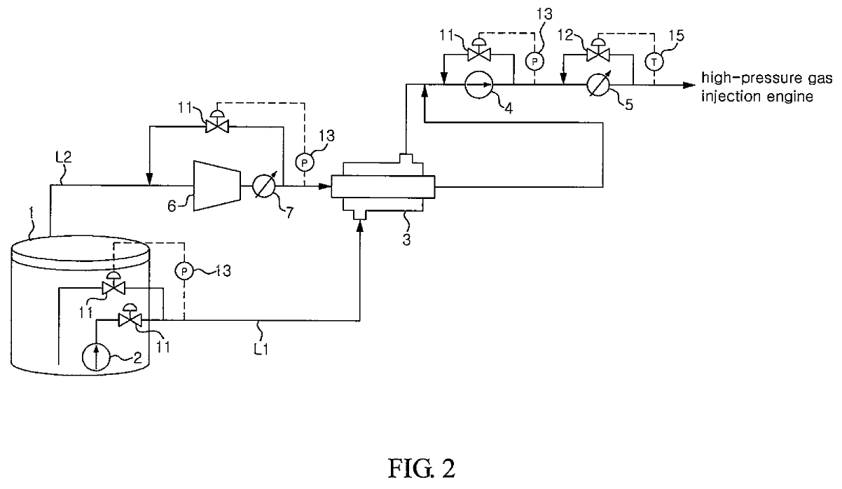

In one embodiment, as illustrated in FIG. 2, the boil-off liquefaction line L2 may be configured such that it passes through the heat exchanger 3 from an upper portion of the LNG fuel tank 1 and is connected between the heat exchanger 3 and the heater 5 in the middle of the fuel gas supply line L1. According to this configuration, boil-off gas is liquefied by heat exchange with the LNG in the heat exchanger 3, compressed in a liquid state, gasified, and then used as fuel gas of the high-pressure gas injection engine.

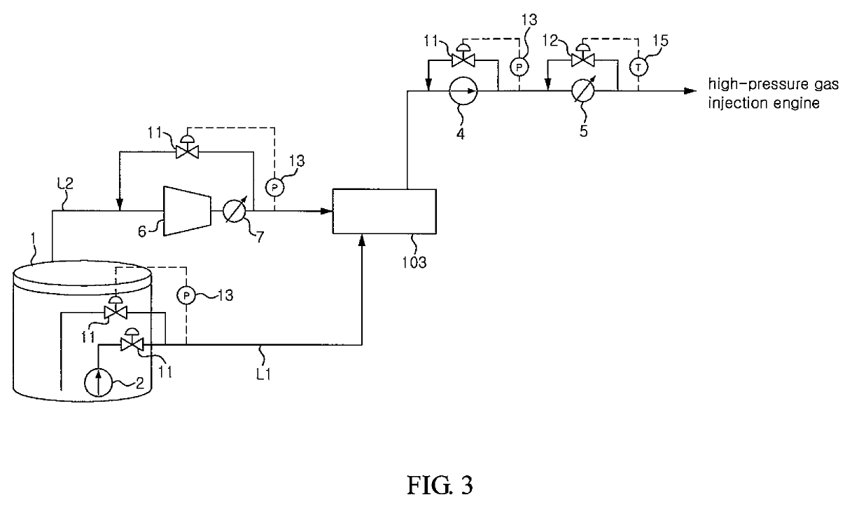

According to the above-mentioned embodiment, the heat exchanger 3 for exchanging heat between the LNG and the boil-off gas extracted from the LNG fuel tank 1 is installed in the middle of the fuel gas supply line L1. However, instead of the heat exchanger 3, a recondenser for directly mixing the LNG and the boil-off gas may be installed. According to the embodiment illustrated in FIG. 3, a recondenser 103 instead of a heat exchanger is installed in the fuel gas supply line L1. The recondenser 103 generates condensed LNG by mixing/liquefying the LNG extracted from a lower portion of the LNG fuel tank 1 and the boil-off gas extracted from the upper portion of the LNG fuel tank 1. The LNG condensed in the recondenser 103 is supplied to the high-pressure gas injection engine through the fuel gas supply line L1.

Also, according to the fuel gas supply system of a ship of the present invention, the boil-off gas generated in the LNG fuel tank is not compressed in a gas state at a high pressure, and thus is not used as fuel gas of the high-pressure gas injection engine.

Additionally, the LNG fuel tank used in the fuel gas supply system of a ship according to embodiments of the present invention may be designed such that it has strength enough to withstand a pressure increase due to the boil-off gas so as to allow the pressure increase due to the boil-off gas generated in the LNG fuel tank during the voyage of the ship.

Further, the fuel gas supply system of a ship according to embodiments of the present invention may include a boil-off gas reliquefaction apparatus comprising a cold box and a refrigeration system. In one embodiment of the present invention, a heat exchanger is installed in the middle of the fuel gas supply line, and the boil-off gas generated in the LNG fuel tank exchanges heat with the LNG in the middle of the fuel gas supply line, and thereby is liquefied. In another embodiment of the present invention, a recondenser is installed in the middle of the fuel gas supply line, and the boil-off gas generated in the LNG fuel tank exchanges heat is mixed with the LNG extracted from the LNG fuel tank, and is supplied to the high-pressure gas injection engine through the fuel gas supply line. Consequently, according to this embodiment, the boil-off gas reliquefaction apparatus which is additionally installed may be configured to have a small capacity.

As apparent from the above, in a fuel gas supply system and method of a ship according to embodiments the present invention, LNG is extracted from an LNG fuel tank, compressed at a high pressure, gasified, and supplied to a high-pressure gas injection engine. Consequently, the fuel gas supply system and method have advantages of simplifying the configuration, reducing power requirements, and preventing an excessive pressure increase due to accumulation of boil-off gas in the LNG fuel tank, in supplying fuel gas to the high-pressure gas injection engine in a ship.

Though the present invention has been shown and described herein with references to the specified embodiments, it would be understood that various modifications, variations, and corrections may occur to those skilled in the art, and thus the description and drawings herein should be interpreted by way of illustrative purpose without limiting the scope and spirit of the present invention.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A fuel gas supply system of a ship for supplying fuel gas to a high-pressure gas injection engine of the ship, the fuel gas supply system comprising:
an LNG fuel tank for storing LNG as fuel;
a fuel gas supply line connected from the LNG fuel tank to the high-pressure gas injection engine of the ship;
means for compressing the LNG installed in the fuel gas supply line between the LNG fuel tank and the high-pressure gas injection engine; and
means for gasifying the LNG installed downstream of the compressing means in the fuel gas supply line, to gasify the compressed LNG.

2. The fuel gas supply system of a ship according to claim 1 wherein the compressing means is configured to extract LNG from the LNG fuel tank, compress the extracted LNG at a high pressure, and supply the compressed LNG toward the high-pressure gas injection engine.

3. The fuel gas supply system of a ship according to claim 1 wherein the compressing means comprises one pump.

4. The fuel gas supply system of a ship according to claim 3 wherein the compressing means further comprises another pump.

5. The fuel gas supply system of a ship according to claim 3, further comprising:
a heat exchanger installed downstream of the one pump in the fuel gas supply line; and
a boil-off gas liquefaction line connected from an upper portion of the LNG fuel tank, passing through the heat exchanger, to one side of the LNG fuel tank, the boil-off gas liquefaction line configured to liquefy boil-off gas generated in the LNG fuel tank.

6. The fuel gas supply system of a ship according to claim 4, further comprising:
a heat exchanger installed between the one pump and the other pump in the fuel gas supply line; and
a boil-off gas liquefaction line passing through the heat exchanger from an upper portion of the LNG fuel tank and connected between the heat exchanger and the gasifying means.

7. The fuel gas supply system of a ship according to claim 3, further comprising:
a recondenser installed downstream of the one pump in the fuel gas supply line.

8. The fuel gas supply system of a ship according to claim 1 wherein the gasifying means is a heater.

9. The fuel gas supply system of a ship according to claim 1 wherein LNG is extracted from the LNG fuel tank and then compressed to approximately 100 to 300 bar gauge pressure.

10. The fuel gas supply system of a ship according to claim 5 wherein the boil-off gas generated in the LNG fuel tank is not compressed in a gaseous state at a high pressure, and thus is not used as fuel gas of the high-pressure gas injection engine.

11. The fuel gas supply system of a ship according to claim 1 wherein the LNG fuel tank is designed to withstand a pressure increase due to the boil-off gas so as to allow a pressure increase due to the boil-off gas generated in the LNG fuel tank during the voyage of the ship.

12. A fuel gas supply method of a ship for supplying fuel gas to a high-pressure gas injection engine of the ship, comprising:
extracting LNG from an LNG fuel tank for storing LNG as fuel of the ship;
compressing the extracted LNG to meet the pressure requirements for the high-pressure gas injection engine;
gasifying the compressed LNG; and
supplying the gasified LNG to the high-pressure gas injection engine.

13. The fuel gas supply method of a ship according to claim 12, further comprising:
extracting a boil-off gas from the LNG fuel tank; and
exchanging heat between the LNG and the boil-off gas before supplying the LNG to the high-pressure gas injection engine.

14. The fuel gas supply method of a ship according to claim 13, further comprising:
liquefying the boil-off gas; and
returning the liquefied boil-off gas to the LNG fuel tank.

15. The fuel gas supply method of a ship according to claim 13, further comprising:
increasing a temperature of the LNG via the exchanging of heat between the LNG and the boil-off gas before supplying the LNG to the high-pressure gas injection engine;
liquefying the boil-off gas; and
supplying the liquefied boil-off gas to the high-pressure gas injection engine.

16. The fuel gas supply method of a ship according to claim 12, further comprising:
mixing the LNG with the boil-off gas extracted from the LNG fuel tank; and
supplying the mixture of the LNG and the boil-off gas to the high-pressure gas injection engine.

17. The fuel gas supply method of a ship according to claim 12 wherein the LNG is gasified by being heated.

18. The fuel gas supply method of a ship according to claim 12, further comprising:
allowing a pressure increase due to the boil-off gas generated in the LNG fuel tank during the voyage of the ship.

19. The fuel gas supply method of a ship according to claim 12 wherein the LNG pressure for the high-pressure gas injection engine ranges from about 100 bar to about 300 bar gauge pressure.

20. The fuel gas supply method according to claim 13 wherein the boil-off gas generated in the LNG fuel tank is not compressed in a gaseous state at a high pressure, and thus is not used as fuel gas of the high-pressure gas injection engine.
